(19) United States
(12) Patent Application Publication
(10) Pub. No.: US 2025/0105313 A1
(43) Pub. Date: Mar. 27, 2025

(54) Fuel Cell

(71) Applicant: SYMBIO FRANCE, Venissieux (FR)

(72) Inventors: Jacky Chaussee, Quincy Voisins (FR); Vianney Boniface, Fontaine (FR); Dominique Auclair, Seyssins (FR); Bilal Naim, Fontaine (FR); Paul Billemaz, Venissieux (FR)

(21) Appl. No.: 18/832,344

(22) PCT Filed: Dec. 23, 2022
(86) PCT No.: PCT/EP2022/087804

§ 371 Date: Jul. 23, 2024

(30) Foreign Application Priority Data
Jan. 24, 2022 (FR) FR2200562
Jan. 24, 2022 (FR) FR2200565

(51) Int. Cl. H01M 8/0202; B60L 50/70; B60R 16/033; H01M 8/04537; H01M 8/2465

(52) U.S. Cl. CPC H01M 8/0269; H01M 8/04537; H01M 8/2465; B60L 50/70; B60R 16/033; H01M 2250/20

(57) ABSTRACT

The invention relates to a fuel cell comprising a stack of bipolar plates in a stacking direction, each two consecutive bipolar plates forming at least one cell therebetween, the stack further comprising two end plates on either side of the stack, a plurality of measurement modules, each module comprising at least one printed circuit comprising a computer capable of determining diagnostic and prognostic characteristics of the stack of bipolar plates, and a mechanical frame for holding the measurement modules, in which the measurement modules are fixed to the mechanical frame, connected to one another and connected to the stack of bipolar plates, without the intermediary of cables.

The present invention relates to a fuel cell.

Fuel cells are used as an energy source in various applications, in particular in electric vehicles. In polymer membrane electrolyte fuel cells (PEFC), hydrogen is supplied to the anode of the fuel cell and oxygen is supplied as an oxidant to the cathode. Polymer membrane fuel cells (PEFC) comprise a membrane-electrode assembly (MEA) comprising an electrically non-conductive, proton exchange, solid polymer electrolyte membrane having the anode catalyst on one side thereof and the cathode catalyst on the opposite side thereof. A membrane-electrode assembly (MEA) is sandwiched between a pair of electrically conductive elements, called bipolar plates, by means of gas diffusion layers, made e.g. of carbon fabric. Bipolar plates are generally rigid and thermally conductive. Same serve mainly as current collectors for the anode and cathode and contain channels with suitable openings to distribute the gaseous reactants from the fuel cell over the surfaces of the respective anode and cathode catalysts and to remove the water produced at the electrode.

A fuel cell is powered by a fuel which is hydrogen that is supplied to the anode and a oxidant which is oxygen or air that is supplied to the cathode.

For example, U.S. Pat No. 9,997,792 discloses a fuel cell comprising a stack of cells, connected to a computer by means of a ribbon of cables connected to each of the cells by connection tabs, the cables being held by a harness to press the cables against the connection tabs.

However, the measurements made with such type of arrangement are unreliable and the cell takes up a large space, moreover the cables tend to be damaged due to mechanical stresses such as vibrations or expansions generated during the operation of the cell, and hence reduce the service life.

There is thus a need to improve the reliability of measurements, reduce the overall size of the fuel cell and improve the service life thereof.

To this end, the subject matter of the present invention is a fuel cell comprising a stack of bipolar plates in a direction of stacking, two consecutive bipolar plates forming a cell between them, the cell further comprising two end plates on each side of the stack, a plurality of measuring modules connected to the bipolar plates, each module comprising at least one printed circuit including a computer suitable for determining the electrical characteristics of the stack of bipolar plates, and a mechanical frame for holding the measuring modules, wherein the measuring modules are fastened to the mechanical frame, connected to each other and connected to the stack of bipolar plates, without the intermediary of cables.

The fuel cell can comprise one or a plurality of the following features, taken individually or according to any technically possible combinations:
The mechanical frame comprises two pivot supports, each pivot support being fastened to an end plate, one pivot shaft extending from one pivot support to the other pivot support substantially parallel to the direction of stacking, and a mounting rail extending from one pivot support to the other pivot support substantially parallel to the direction of stacking and to the pivot shaft, the mechanical frame being configured so that all measurement modules are framed by the frame.
The fastening rail is provided with holes for the passage of the fastening means of each pivot support to the fastening rail, the holes for the passage of the fastening means of the fastening rail being oblong.
Each module is covered with a shell, the shells of each module comprising foolproof members and being assembled to each other by foolproofing.
The foolproof devices include a male fastener mating a female fastener, whereas each shell is provided on a first transverse side with the male fastener, while the female fastener is formed in a second transverse side of the shell opposite the first side.
The male fastener is a stud and the female fastener is an arc-shaped groove allowing the stud to pivot in the groove.
Each shell has a cylindrical groove mating with the pivot shaft.
Each shell has a lug for fastening to the mounting rail.
Each module is connected to an inter-module connector strip having leaf springs placed on each side of the strip along a transverse direction perpendicular to the direction of stacking, in such a way that the contact of the shell of a first module with the shell of a second neighboring module generates a compression of the leaf springs of each of the strips.
Each module is connected to the stack of bipolar plates by means of pins that can be inserted into pockets formed in the bipolar plates.
One of the pivot supports carries a connector for linking the stack of bipolar plates to a motherboard.
One of the pivot supports carries an additional component for contact with the bipolar plate closest to said pivot support, suitable for connecting said bipolar plate to the neighboring module.

A further subject matter of the present invention is a vehicle comprising at least one fuel cell as defined hereinabove.

A further subject matter of the present invention is a method for installing measurement modules on a fuel cell according to the invention, comprising the fastening of each module to the mechanical frame, and connecting the modules to each other and to the stack of bipolar plates without the intermediary of cables.

Another aspect of the invention relates to a fuel cell formed by a stack of a plurality of bipolar plates along a direction of stacking, each bipolar plate being as such formed by two superimposed monopolar plates comprising an anode plate and a cathode plate, two consecutive bipolar plates forming a cell therebetween, the fuel cell further comprising two end plates on either side of the stack, a plurality of modules for measuring the electrical characteristics of the cells, each module comprising a printed circuit including a computer suitable for determining the electrical characteristics of the stack of bipolar plates, wherein two successive monopolar plates together form at least one pocket each for receiving a pin of said module, each pocket being shaped to cooperate with said pin and having a circumferential wall, and wherein each pin of the module has a shape such that the pin exerts two opposing forces on the circumferential wall of the pocket after the pin is inserted into the pocket.

The fuel cell can comprise one or a plurality of the following features, taken individually or according to any technically possible combination:
Two successive monopolar plates are arranged back-to-back to form at least one pocket.
Each pin extends mainly along a first direction, and has, over a portion, an incision along said first direction separating said portion into two sub-portions on each side of the incision, each sub-portion having a bulge in a second direction, the second direction being perpendicular to the first direction, the bulges of the two sub-portions extending in opposite directions along the second direction.
The second direction is perpendicular to a third direction which is perpendicular to the first direction, the two sub-portions being separated from each other on each side of the incision in the third direction.
The incision extends along the first direction between a proximal end and a distal end, and the two sub-portions are linked together at distal and proximal ends of the incision.
Each pocket has an open end where the circumferential wall has a conical shape.
The circumferential wall of each pocket has a stamping so as to form a passage of small cross-section for a pin.
Two successive bipolar plates are stacked head-to-tail, so that only the at least one pocket of every other bipolar plates is flush in the vicinity of the modules.
Each bipolar plate forms exactly two pockets for receiving a pin each.

Each module has ten aligned pins configured to connect ten pockets of ten distinct bipolar plates to said module, and an additional pin to connect the second pocket of one of the ten bipolar plates to said module.

A further subject matter of the present invention is a vehicle comprising at least one fuel cell as defined hereinabove.

The invention will be better understood upon reading the following description, given only as an example and making reference to the drawings, wherein:

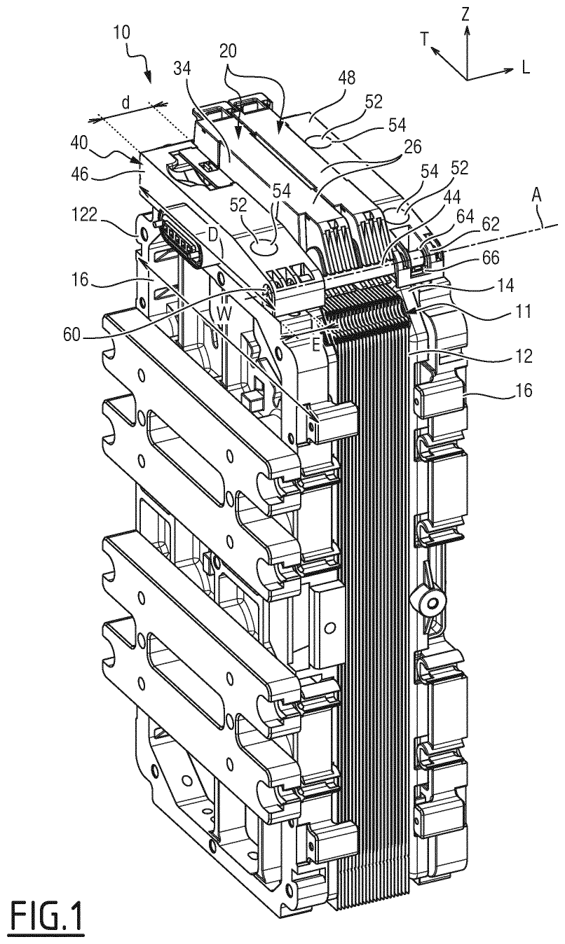

FIG. 1 is a schematic perspective front and side view of a fuel cell according to a first embodiment of the invention;

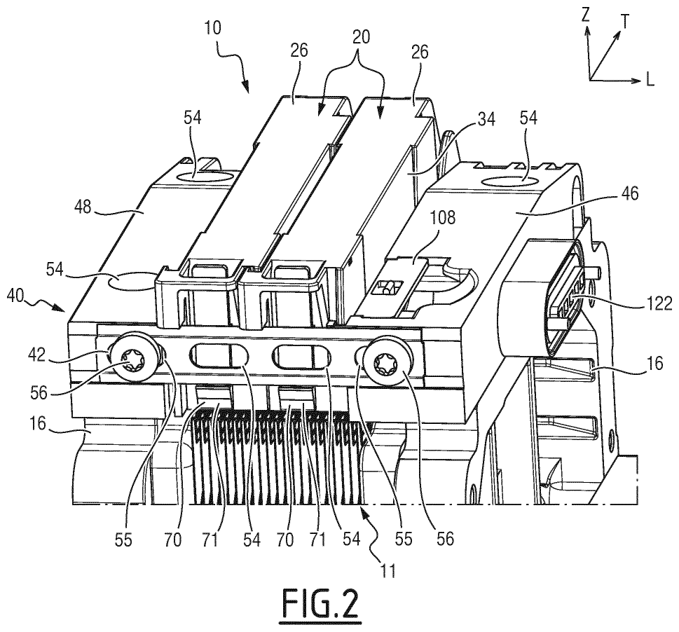

FIG. 2 is a schematic perspective rear view of a stack of the fuel cell shown in FIG. 1;

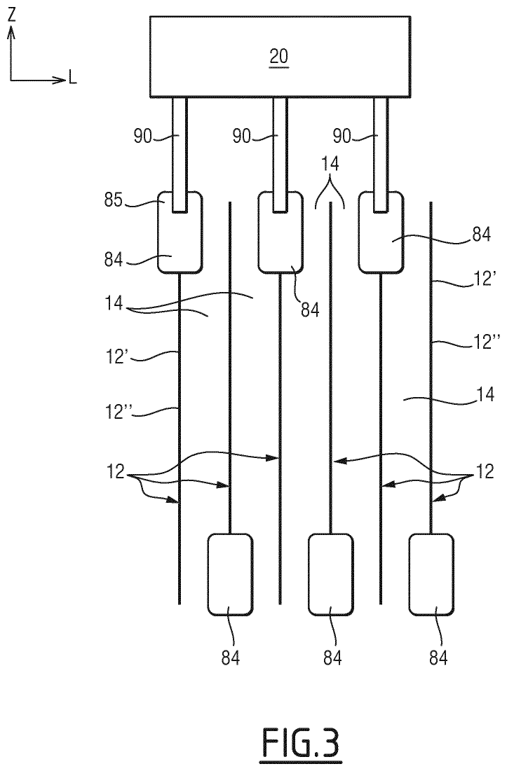

FIG. 3 is a schematic view of a stack of bipolar plates of the fuel cell shown in FIG. 1;

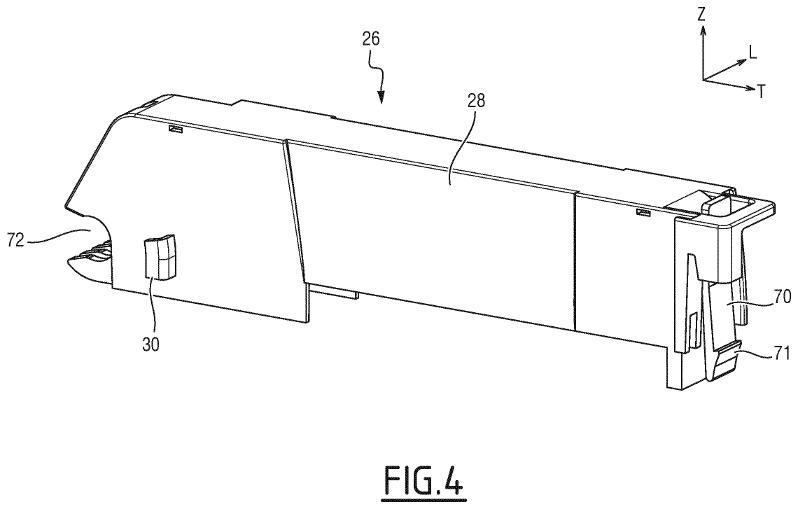

FIG. 4 is a schematic view of a first transverse side of a shell for a measurement module of the fuel cell shown in FIG. 1;

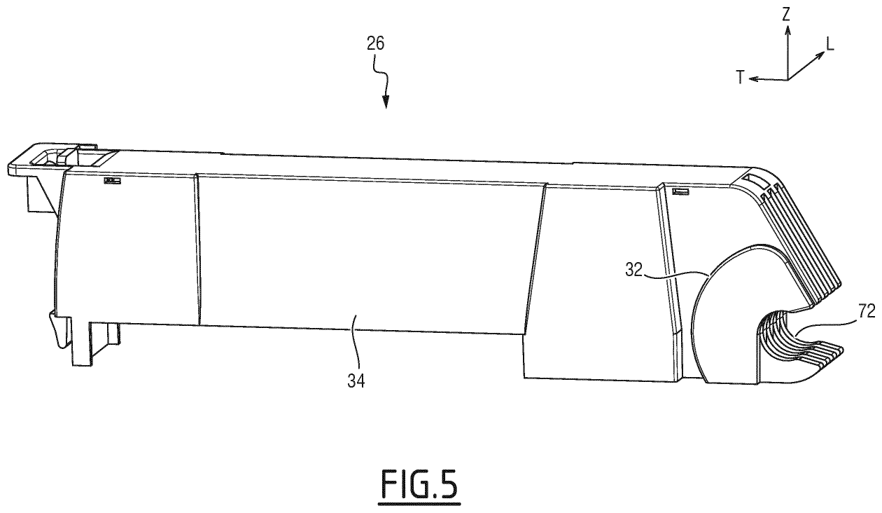

FIG. 5 is a schematic view of a second transverse side of a shell for a measurement module of the fuel cell shown in FIG. 1;

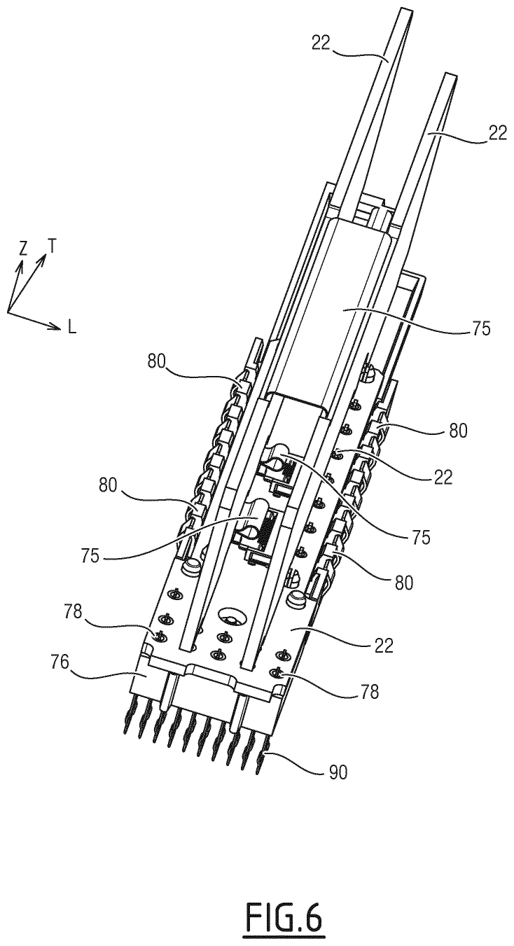

FIG. 6 is a schematic top view of the fuel cell shown in FIG. 1 wherein the module shells have been removed;

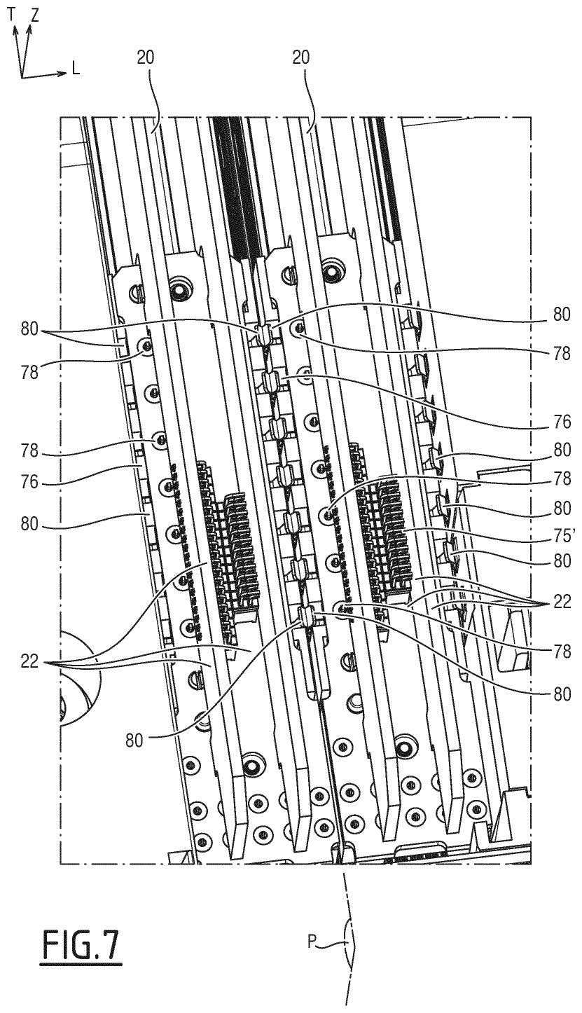

FIG. 7 is a schematic top view of the fuel cell shown FIG. 1 wherein the module shells have been removed, according to a variant of FIG. 6;

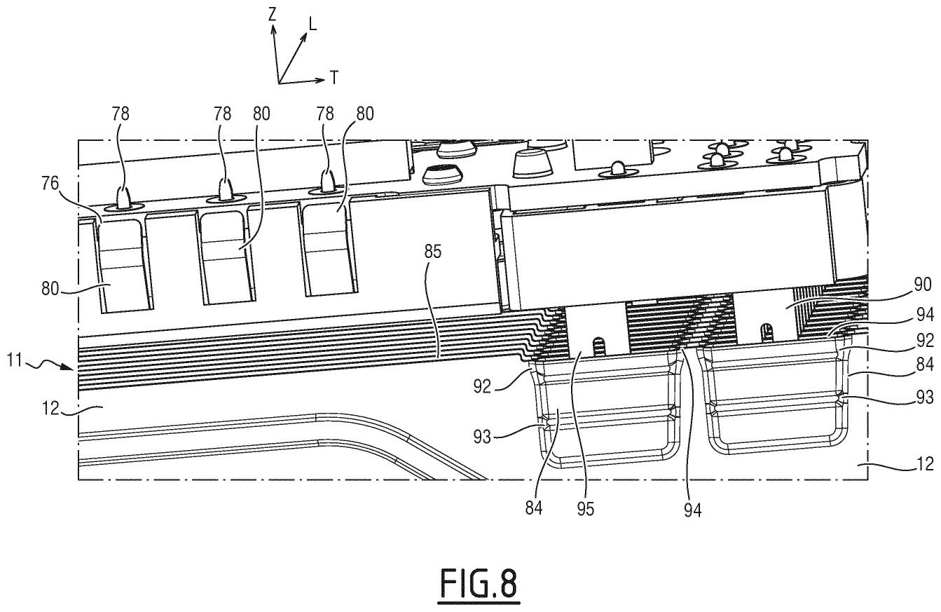

FIG. 8 is a schematic perspective view of the connection between the modules and the cells of the stack of bipolar plates of the fuel cell shown in FIG. 1;

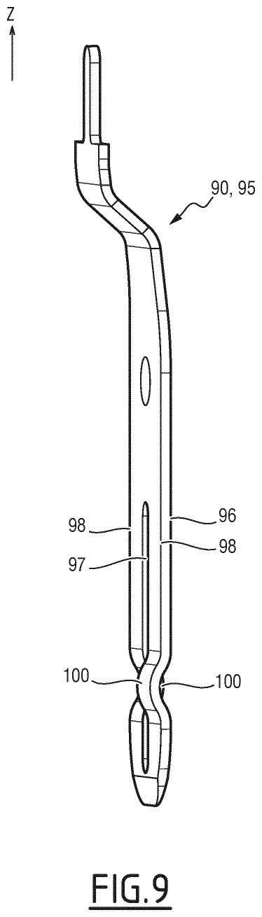

FIG. 9 is a schematic view of a pin of a measurement module of the fuel cell shown in FIG. 1; and

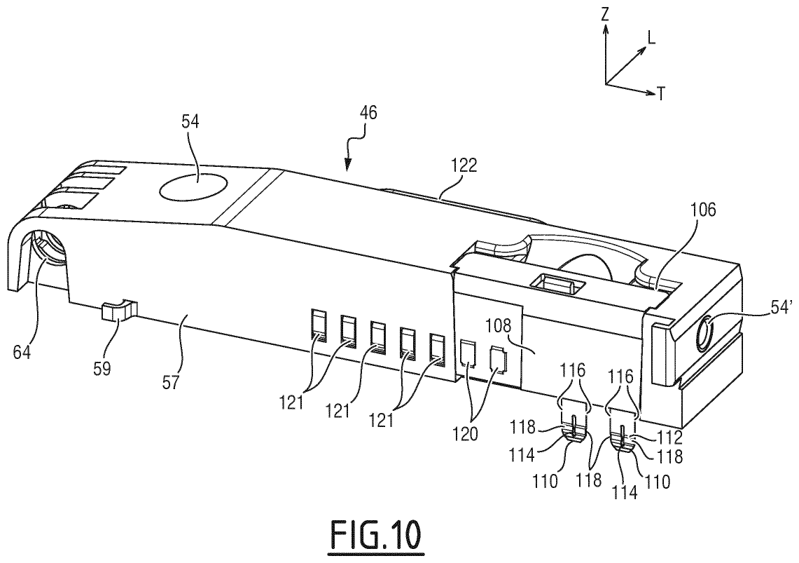

FIG. 10 is a schematic view of a first transversal side of a pivot support of the fuel cell shown in FIG. 1.

FIGS. 1 and 2 show a fuel cell 10 formed by a stack 11 of bipolar plates 12.

Each bipolar plate 12 is herein formed by two superimposed monopolar plates 12′, 12″ comprising an anode plate 12′ and a cathode plate 12″, visible in FIG. 3. A cooling circuit is advantageously arranged between the two monopolar plates, which are assembled to each other in a sealed manner.

In the example shown, the two monopolar plates 12′ and 12″ associated with the same bipolar plate 12 are made of metal and are welded or bonded together.

In a variant (not shown), the monopolar plates are assembled in another way, e.g. by means of a directly mounted seal, e.g. a silicone seal. According to another variant (not shown), the bipolar plates are in one-piece, e.g. made of graphite.

More particularly, the fuel cell 10 includes a plurality of cells 14 made in the form of a stack 11 of bipolar plates 12, a cell 14 being formed between two consecutive bipolar plates 12. A stack 11 thereby consists of a plurality of individual cells 14 connected in series. For each individual cell 14, the fuel cell 10 further comprises a membrane-electrode assembly, which is interposed between the two bipolar plates 12 associated with the cell 14. The membrane-electrode assemblies are not shown.

The fuel cell 10 is e.g. intended to be used in a motor vehicle.

The bipolar plates 12 are stacked along a direction of stacking.

Hereinafter in the description, the direction of stacking is defined as being the longitudinal direction L.

The fuel cell 10 also comprises two end plates 16, which are arranged on each side of the stack 11. The bipolar plates 12 are sandwiched between the two end plates 16.

The end plates 16 are e.g. made of aluminum.

External fluidic circuits (not shown) are connected to the fuel cell 10 at the end plates 16 and the reactive gases are distributed to the membrane electrode assemblies on the surface of the bipolar plates 12 via channels etched thereon.

In order to measure the electrical characteristics of the cells 14, measurement modules 20 are connected to the stack 11 of bipolar plates 12.

Each module 20 serves to monitor the state of the stack 11 in order to adapt the control of the fuel cell system 10.

Each module 20 comprises at least one printed circuit 22, more particularly three printed circuits 22, including a computer suitable for determining diagnostic and prognostic characteristics of the stack 11 of bipolar plates 12, visible in FIGS. 6 and 7 discussed in detail below.

For example, the characteristics comprise a state of health of the stack 11 of bipolar plates 12, the location of a cell 14 in the stack of bipolar plates 12, the voltage, the impedance and the supply of the cells 14 of the fuel cell 10.

The modules 20 are each covered with a shell 26 intended to cover the printed circuits 22 and to protect same.

The shells 26 have multiple functionalities, which will be discussed in detail hereafter.

The shells 26 of the modules 20 are in particular foolproofings.

The modules 20 are thus configured to be assembled together without any possible error. The term “without any possible error” means that two neighboring modules 20 are configured to be assembled to each other in a single relative orientation of the two modules 20 once assembled, unless, of course, the modules 20 are assembled by force, by deforming the material of the shells 26. Thus, the assembly of a measurement module 20 to another module 20 is possible only in one configuration. Such an assembly without possible orientation error is also called a foolproof assembly.

For example, as shown in FIG. 4, each shell 26 is provided on a first transverse side 28 with a male fastener 30 which mates with a female fastener 32 formed in a second transverse side 34 of the shell 26 opposite the first side 28, visible in FIG. 5. Thereby, the shells 26 can be assembled together without any risk of error.

For example, the male fastener 30 is a stud and the female fastener 32 is an arc-shaped groove allowing the stud to pivot in the groove.

More generally, the male 30 and female 32 fasteners together form an example of foolproofing members, which cooperate with each other by mating shapes and which can be assembled to each other in only one configuration.

In addition, the modules 20 are configured to be assembled to the bipolar plates 12 without any possible error. Each module 20 is preferably assembled to the bipolar plates 12 by foolproofing.

The shells 26 protect the printed circuits 22 of the modules 20.

Preferably, the shells 26 of all the modules 20 are identical.

The modules 20 are assembled together and to the stack 11 of bipolar plates 12 in particular by means of a mechanical frame 40.

Returning to FIGS. 1 and 2, the mechanical frame 40 advantageously comprises a fastening rail 42, a pivot shaft 44 and two pivot supports 46, 48.

Each pivot support 46, 48 is arranged so as to be in contact with an end plate 16 and a module 20 when same is installed.

The pivot supports 46, 48 extend mainly along a transverse direction T perpendicular to the longitudinal direction L. A direction of elevation Z is also defined, which is orthogonal to the longitudinal direction L and to the transverse direction T, so that the longitudinal, transverse and elevation directions form a direct coordinate system.

Each pivot support 46, 48 has a large dimension D, defined along the transverse direction T, less than a maximum width W of the respective end plate 16 defined along the transverse direction T.

Preferably, each pivot support 46, 48 has a large dimension D comprised between 70% and 80% of a maximum width W of the respective end plate 16.

Each pivot support 46, 48 has a small dimension d, defined along the longitudinal direction L, substantially equal to a thickness E of the respective end plate 16 defined along the longitudinal direction L.

Advantageously, each of the two end plates 16 is provided with at least one orifice for receiving means 52 for fastening a pivot support 46, 48 to the respective end plate 16.

For example, the fastening means 52 are screws.

According to such example, the at least one receiving orifice 50 is tapped.

Each pivot support 46, 48 has at least one orifice 54 through which the means 52 for fastening to the respective end plate 16 pass. The at least one through orifice 54 for the passage of fastening means 52 is configured to be placed opposite the at least one receiving orifice 50 provided in the respective end plate 16.

More particularly, each pivot support 46, 48 is fastened to one of the two end plates 16 by means of two screws 52. Each screw 52 is e.g., a domed screw with six internal lobes of diameter 6 mm and a length of 16 mm, having a strength class 8.8 and being made of steel and zinc.

The fastening rail 42 extends from one pivot support 46, 48 to the other along the longitudinal direction L.

Advantageously, the fastening rail 42 is provided with orifices 55 for the passage of means 56 for fastening each pivot support 46, 48 to the fastening rail 42.

Each pivot support 46, 48 has at least one through-hole 54′ for the passage of the means 56 for fastening to the fastening rail 42.

For example, the fastening means 56 are screws.

More particularly, each pivot support 46, 48 is fastened to the fastening rail 42 by means of a screw 56. The screw 56 is, e.g., a domed screw with six internal lobes of diameter 6 mm and length 16 mm, having a strength class 8.8 and being made of steel and zinc.

Advantageously, the holes 55 through which the means 56 for fastening the fastening rail 42 pass are oblong.

The oblong holes 55 give rise to a slight clearance of the fastening rail 42 on the pivot supports 46, 48 along the longitudinal direction L and thereby improve the resistance of the modules to vibrations and expansions caused during the service life of the fuel cell 10.

Advantageously, as can be seen in FIG. 10, each pivot support 46, 48 is provided on a transverse side 57 intended to be in contact with a module 20 with a male or female fastener 59, respectively, mating with the female fastener 32, or male fastener 30, respectively, formed in a transverse side 28, 34 of the shell 26 of each module 20. Thereby, the shells 26 can be assembled to the pivot supports 46, 48 without any risk of error.

For example, the male fastener 59 is a stud and the female fastener 61 is an arc-shaped groove allowing the stud to pivot in the groove.

The pivot shaft 44 extends between two longitudinal ends 60, 62.

The pivot shaft 44 extends parallel to the fastening rail 42.

Each longitudinal end 60, 62 of the pivot shaft 44 is held by a respective pivot support 46, 48.

To this end, the pivot support 46, 48 has, e.g., two aligned cylindrical through-holes 64 for receiving the pivot shaft 44.

The pivot shaft 44 preferably has a groove configured to be located between the two through-holes 64 for receiving the pivot shaft 44 when the pivot shaft 44 is engaged in the respective pivot support 46, 48.

Each pivot support 46, 48 advantageously also has a tab 66 placed between the two through-holes 64 for receiving the pivot shaft 44.

The pivot shaft 44 is locked in position at the tab 66. When the stack 11 compresses or expands, the pivot support 46 moves in translation along the pivot shaft 44.

The pivot supports 46, 48 mechanically hold the entire system formed by the pivot shaft 44 and the fastening rail 42.

The shells 26 of the modules 20 are fastened to the fastening rail 42, e.g. by means of a lug 70 comprising a locking tooth 71.

The lug 70 advantageously extends along a direction of elevation Z perpendicular to the longitudinal direction L and to the transverse direction T.

The shells 26 of the modules 20 are fastened to the pivot shaft 44, e.g. by means of a cylindrical groove 72 which mates with the pivot shaft 44. The groove 72 has e.g. a striated contour. In a variant, the groove 72 has e.g. a solid contour.

When the shell 26 of a module 20 is fastened to the pivot shaft 44 but not to the fastening rail 42, the shell 26 is movable in rotation about an axis A formed by the pivot shaft 44.

The shells 26 of modules 20, when assembled together by means of the male fastener 30 and the female fastener 32, to the fastening rail 42 and to the pivot shaft 44, are thereby locked against translation along the transverse T and elevation Z directions, and in rotation.

A slight play is permitted along the longitudinal direction L to limit wear due to vibration and expansion.

According to the example shown in FIG. 6, each module 20 comprises three printed circuits 22. A printed circuit 22 extends mainly along the transverse direction T and two printed circuits 22 extend mainly along the direction of elevation Z.

The three printed circuits 22 are electrically connected to each other by ribbons 75 of cables, e.g. two ribbons 75 between the printed circuit 22 extending mainly along the transverse direction T and one of the two printed circuits 22 extending mainly along the direction of elevation Z, and a ribbon 75 between the two printed circuits 22 extending mainly along the direction of elevation Z.

In order to electrically connect the modules 20 to one another, and to ensure continuity of the measurements of the electrical characteristics of the cells 14, each module 20 is connected to a strip 76 for connecting modules 20 together.

According to the example shown in FIG. 6, the strip 76 is in the form of two half-strips arranged on either side of a median transverse plane P of the module 20. The strip 76 extends mainly along a transverse direction T.

Preferably, the strip 76 is arranged in the vicinity of the lug 70 for fastening the shell 26 to the fastening rail 42.

The strip 76 includes a plurality of pins 78 for connecting the strip 76 to at least one printed circuit 22 of the module 20.

The pins 78 are oriented along the direction of elevation Z.

The pins 78 serve to mechanically and electrically connect the strip 76 and the module 20.

The strip 76 further comprises leaf springs 80 placed on each side of the strip 76 along the transverse direction T.

The strip 76 has e.g., seven pairs of leaf springs 80.

The leaf springs 80 are domed.

The strip 76 is assembled to the module 20 so that the pins 78 of the strip 76 are located between the strip 76 and the printed circuits 22.

In this way, when the strip 76 is assembled to a module 20, the leaf springs 80 protrude from each transverse side 28, 34 of the shell 26 of the module 20.

The leaf springs 80 of the shells 26 of two adjacent modules 20 compensate for the compression and expansion that may occur during the service life of the fuel cell 10, and hence ensure mechanical and electrical contact, at any time, between the strips 76 of the two shells 26, and consequently between two neighboring modules 20.

The leaf springs 80 are an example of preferred embodiment of contactors between two neighboring modules 20.

The strip 76 ensures continuity in the measurement of the electrical characteristics of the cells and creates a connection line to link all the modules 20 by a supply line and a communication bus, without the use of cables between the modules 20. Each module 20 is thereby supplied with energy for its own operation, in particular for the operation of the printed circuit 22, for carrying out measurements of the electrical characteristics, for transmitting the results of measurements, etc. Advantageously, when one of the modules 20 of the fuel cell 10 fails, thereof does not prevent the other modules 20 of the cell 10 from functioning.

In a variant, as can be seen in FIG. 7, the three printed circuits 22 are electrically connected to each other by contacts 75′, e.g. a plurality of contacts 75′ between the printed circuit 22 extending mainly along the transverse direction T and one of the two printed circuits 22 extending mainly along the direction of elevation Z, and a plurality of contacts 75′ between the printed circuit 22 extending mainly along the transverse direction T and the other of the two printed circuits 22 extending mainly along the direction of elevation Z. According to such variant, the strip 76 has the same shape as in the variant of FIG. 6.

Advantageously, the cells 14 are arranged in packets of twenty cells 14.

Twenty cells 14 require twenty-one bipolar plates 12.

To this end, twenty-one bipolar plates 12 are stacked and two consecutive bipolar plates 12 delimit a cell 14 therebetween.

Two successive monopolar plates 12′, 12″ are advantageously arranged back to back and form therebetween at least one pocket 84 at one end 85 of the bipolar plate 12 along the direction of elevation Z.

Each pocket 84 is configured to receive a pin 90 of a module 20 for measuring the electrical characteristics of the cells 14.

Preferably, two successive bipolar plates 12 are stacked head-to-tail, as can be seen in FIG. 3, so that only the at least one pocket 84 of every two bipolar plates 12 is flush in the vicinity of the modules 20.

According to the example shown, each bipolar plate 12 forms exactly two pockets 84 for receiving a pin 90 each.

The second pocket 84 makes it possible to measure four wires per group of twenty cells 14. Same is used for measuring impedances.

More particularly, each pocket 84 is shaped to cooperate with said pin 90.

For each pocket 84, the two successive bipolar plates 12 delimit a circumferential wall 92 of the pocket 84 when same are in contact with each other.

Preferably, each pocket 84 has an open end 94 where the circumferential wall 92 has a conical shape.

Such a shape has the advantage of guiding the pin 90 of a module 20 inside said pocket 84.

Advantageously, the circumferential wall 92 of each pocket 84 has a stamping 93 so as to form a passage of small cross-section for a pin 90.

The stamping 93 plays a role in stiffening the pocket 84, and makes it possible to ensure the electrical contact inside the pocket 84 between the pin 90 and the pocket 84.

The stamping 93 also has a function of locking the pin 90 in depth when same is inserted into the pocket 84, and making it possible to avoid piercing said pocket 84.

Each module 20 advantageously includes ten aligned pins 90 configured to connect ten pockets 84 of said bipolar plates 12 to said module 20, and an additional pin 95 configured to connect the second pocket 84 of one of the ten bipolar plates 12, as can be seen in FIG. 8.

The ten aligned pins 90 serve for measuring the voltage of two consecutive cells 14 between two consecutive pins 90.

The additional pin 95 is arranged substantially parallel to the alignment of pins 90 and preferably at a longitudinal end of the module 20.

The additional pin 95 is configured to inject current into the pocket 84 wherein same is received, and thereby makes it possible to measure the impedance on twenty cells 14. Thereby, each module 20 is apt to measure one impedance every twenty cells 14.

Each pin 90, 95 of the module is advantageously designed to promote an effective and durable electrical contact over time between the module 20 and each bipolar plate 12, as visible in FIG. 9.

To this end, each pin 90, 95 of the module 20 has a shape such that the pin 90, 95 exerts two opposite forces on the circumferential wall 92 of the pocket 84 once the pin 90 has been inserted into the corresponding pocket 84.

The pins 90, 95 of a module 20, are preferably identical.

Thereof facilitates the design of the module.

Each pin 90, 95 extends mainly along a first direction, more particularly the direction of elevation Z, and has, over a portion 96, an incision 97 along said first direction separating said portion 96 into two sub-portions 98 on each side of the incision 97. More particularly, the incision 97 extends along the first direction, herein the direction of elevation Z, between a proximal end and a distal end opposite the proximal end, the two sub-portions 98 being linked to each other at the distal and proximal ends of the incision 97.

Each sub-portion 98 has a bulge 100 along a second direction, more particularly the longitudinal direction L, the second direction being perpendicular to the first direction. The transverse direction T thus forms herein a third direction, which is orthogonal to the second direction and to the first direction.

The bulges 100 of the two sub-portions 98 extend in opposite directions along the second direction, herein the longitudinal direction L, the two sub-portions 98 being separated from each other on each side of the incision 97 along the third direction, herein the transverse direction T.

Thereby, the pin 90, 95 is domed at the sub-portions 98, making same both rigid and slightly elastic. The connection of a pin 90 in a pocket 84 requires forcing the pin in. Thereof guarantees a solid and durable electrical contact between the pin 90 and the respective pocket 84, and consequently with the two monopolar plates 12′, 12″ forming the pocket 84.

The electrical contact is in particular ensured independently of the expansion or of the vibrations which may occur during the service life of the fuel cell 10, due to the spring effect induced by the specific shapes of the pockets 84 and of the pins 90.

According to variants, the pins 90, 95 of each module 20 have a different shape, more particularly any shape technically feasible for connecting each module 20 to the cells 14.

When the modules 20 are connected to the cells 14, there remains at least one pocket 84, formed by a bipolar plate 12 at a longitudinal end 104 of the stack 11 of cells 14, not connected to a module 20. The bipolar plate 12 is called the last bipolar plate 12.

To this end, returning to FIG. 10, one of the pivot supports 46 has a location 106 for fastening an additional component 108 for contact with the last bipolar plate 12.

The additional component 108 has at least one pin 110 intended to be received in a pocket 84 formed by the bipolar plate 12.

More particularly, the additional component 108 has two pins 110.

In the same way as for the modules 20, each pin 110 of the additional component 108 has a shape such that the pin 110 exerts two opposing forces on the circumferential wall of the pocket 84 once the pin 110 has been inserted into the pocket 84.

The two pins two 110 of the additional component 108, are preferably identical.

Each pin 110 extends mainly along a first direction, more particularly the direction of elevation Z, and has, over a portion 112, an incision 114 along said first direction separating said portion into two sub-portions 116 on each side of the incision 114.

Each sub-portion 112 has a bulge 118 along a second direction, the second direction being substantially perpendicular to the first direction.

The bulges 118 of the two sub-portions 116 extend in an opposite direction.

Thereby, the pin 110 is domed at the sub-portions 116, making same both rigid and slightly elastic. The connection of a pin 110 in a pocket 84 requires to force the pin in. Thereof guarantees a solid and durable electrical contact between the pin 110 and the respective pocket 84, and consequently with the two monopolar plates 12′, 12″ forming the pocket 84.

Furthermore, the additional component 108 has at least one metal contact 120, more particularly two metal contacts 120, for the connection with the neighboring module 20.

Furthermore, the pivot support 46 supporting the additional component 108 has at least one metal contact 121, more particularly five metal contacts 120, for the connection with the neighboring module 20.

More particularly, the metal contacts 120, 121 are intended to come into contact with the leaf springs 80 of the strip 76 associated with said neighboring module 20.

As a result, the electrical potential of the last bipolar plate 12 is transmitted to the calculator of the neighboring module 20. Thereby, all the cells 14 of the fuel cell 10 are connected to a module 20 in order to be able to measure the electrical characteristics thereof.

Advantageously, the pivot support 46 supporting the additional component 108 further comprises a connector 122 for linking the stack 11 of bipolar plates 12 to a motherboard. The connector 122 does not require cables.

The mechanical frame 40 holds the entire system formed by the modules 20, the pivot shaft 44, the fastening rail 42 and the pivot supports 46, 48 and permits the expansion of the modules 20.

The shell 26 of each module 20 makes it possible to place the printed circuit 22 very close to the stack 11 while protecting the latter from external damage.

The quality of the measurements made by the modules 20 is improved, allowing modular multifrequency impedance measurements to be made, as will be discussed in detail later further down.

More generally, it will be understood that the electrical characteristics measured by each module 20 are available, through contactors 80, for all the other elements connected to the modules 20. More particularly, if need be, the additional component 108 has access to the measurements of the electrical characteristics of each cell 14. Similarly, the motherboard connected to the connector 122 also has access to the measurements of the electrical characteristics of each cell, or, in the present example, of each set of two consecutive cells, at the terminals of which a voltage measurement is performed by the modules 20.

The contactors 80 and the metal contacts 120 are also configured to transmit electrical energy between neighboring modules 20 or between the additional component 108 and the module 20 adjacent to the additional component 108, which is thereby made available for the operation of the modules 20, in particular for the operation of the printed circuit 22 of each module 20, for making voltage measurements, impedance measurements, for injecting current, etc.

In the example illustrated, the printed circuits 22 of the modules 20 integrate the calculators which determine the diagnostic and prognostic characteristics of the stack 11 of bipolar plates 12. Alternatively, diagnostic and prognostic characteristics are determined elsewhere, e.g. by the motherboard connected to the connector 122, whereas each module 20 determines the electrical characteristics of the stack 11, in particular the measurement of electrical voltages, impedances, etc. It is thereby possible to construct modules 20 with a relatively simple and robust structure, so as to make reliable measurements of the electrical quantities relating to the cells 14.

A method of installing measurement modules 20 on a fuel cell 10 according to the invention will now be described.

A first module 20 is assembled to the mechanical frame 40 in the vicinity of one of the pivot supports 46.

More particularly, the shell 26 of the first module 20 is fastened to the pivot shaft 44, e.g. by means of the cylindrical groove 72 of the shell 26 mating the pivot shaft 44.

The shell 26 of the first module 20 is movable in rotation about an axis A formed by the pivot shaft 44.

The shell 26 of the first module is advantageously fastened to the fastening rail 42 by means of the lug 70, by wedging the fastening rail 42 in the lug 70.

The first module 20 is assembled to one of the pivot supports 46.

More particularly, the male fastener 59 of the pivot support 46 is connected to the female fastener 32 of the first module 20, or the male fastener 30 of the first module 20 is connected to the female fastener of the pivot support 46 according to the arrangement of the male and female members on each module 20 and the pivot support 46.

According to the example shown, the male fastener 30 is a stud and the female fastener 32 is an arc-shaped groove, and the stud 30 pivots in the groove 32.

At least one of the leaf springs 80 of the strip 76 situated on the transverse side 28 oriented toward the pivot support 46 advantageously comes into contact with the at least one metal contact 120 of the additional component 108 for the contact with the last bipolar plate 12 and the at least one metal contact 121 of the pivot support 46.

The contact of the shell 26 of the first module 20 with the at least one metal contact 120, 121 generates a compression of the leaf springs 80 of the strip 76.

Furthermore, each pin 90 of the first module 20 is received in a pocket 84 formed by two consecutive monopolar plates 12′, 12″ of the stack 11 of the fuel cell 10.

More particularly, the ten aligned pins 90 of the first module 20 are received in ten pockets 84 of ten bipolar plates 12, and the additional pin 95 is received in the second pocket 84 of one of the bipolar plates 12.

The ten aligned pins 90 of the first module 20 serve for measuring the voltage of two consecutive cells 14 between two consecutive pins 90.

The prior fastening of the first module 20 to the pivot support 46 and to the mechanical frame 40 ensures that the pins 90 of the first module 20 are received in the corresponding pockets 84.

To this end, each pin 90 of the first module 20 is preferably forced into the respective pocket 84.

The shape of each pocket 84 advantageously guides each pin 90 of the first module 20 inside said pocket 84.

The shape of each pin 90 of the first module 20 favors an effective and durable electrical contact over time between the first module 20 and each bipolar plate 12.

Such an arrangement guarantees a solid and durable electrical contact between the pin 90 and the respective pocket 84, and consequently with the two monopolar plates 12′, 12″ forming the pocket 84.

The electrical contact is in particular ensured independently of the expansion or of the vibrations which may occur during the service life of the fuel cell 10, due to the spring effect induced by the specific shapes of the pockets 84 and of the pins 90.

When the first module 20 is connected to the respective cells 14, the at least one pocket 84 formed by the two monopolar plates 12′, 12″ closest to the pivot support 46 adjacent to the first module 20 does not receive a pin 90 of the first module 20.

To this end, the at least one pin 110 of the additional component 108 for contact with the last bipolar plate 12 is received in said pocket 84.

It is thereby possible to measure the voltage of the two consecutive cells 14 closest to the pivot support 46 neighbor to the first module 20.

More particularly, the two pins 110 of the additional component 108 for contact with the last bipolar plate 12 are received in the two pockets 84 formed by the bipolar plate 12 closest to the pivot support 46 adjacent to the first module 20.

In the same way as for the first module 20, each pin 110 of the additional component 108 for contact with the last bipolar plate 12 is preferably forced into the respective pocket 84.

The shape of each pocket 84 advantageously guides each pin 110 of the additional component 108 for contact with the last bipolar plate 12 inside said pocket 84.

The shape of each pin 110 of the additional component 108 for contact with the last bipolar plate 12 promotes an effective and durable electrical contact over time between the additional component 108 and the bipolar plate 12.

Such an arrangement guarantees a solid and durable electrical contact between the pin 110 and the respective pocket 84, and consequently with the two monopolar plates 12′, 12″ forming the pocket 84.

The electrical contact is in particular ensured independently of the expansion or of the vibrations which may occur during the service life of the fuel cell 10, due to the spring effect induced by the specific shapes of the pockets 108 and of the pins 110.

The method of installing measurement modules 20 comprises assembling a second module 20 to the first module 20 and to the pockets 84 formed by the bipolar plates 12 of the fuel cell 10.

More particularly, the second module 20 is fastened to the pivot shaft 44 and to the fastening rail 42 of the mechanical frame 40 in the same way as the first module 20.

In addition, the male fastener 30 of the first module 20 is connected to the female fastener 32 of the second module 20, or the male fastener 30 of the second module 20 is connected to the female fastener 32 of the first module 20 according to the arrangement of the male and female members on each module 20.

According to the example shown, the male fastener 30 is a stud and the female fastener 32 is an arc-shaped groove, and the stud 30 pivots in the groove 32.

The shells 26 of modules 20, when assembled together by means of the male fastener 30 and the female fastener 32, to the fastening rail 42 and to the pivot shaft 44, are thereby locked against translation along the transverse T and elevation Z directions, and rotate.

The assembly of the shells 26 of the modules 20 together makes possible the automation of the method as well as a saving of time for the insertion of the modules 20 on the stack of bipolar plates 12.

The first module 20 and the second module 20 are electrically connected to each other.

More particularly, the strip 76 of the second module 20 is assembled to the strip 76 of the first module 20.

To this end, at least one of the leaf springs 80 of the strip 76 of the second module 20 located on the transverse side 34 oriented toward the first module 20 advantageously comes into contact with at least one of the leaf springs 80 of the strip 76 of the first module 20.

The contact of the shell 26 of the first module 20 with the shell 26 of the second module 20 generates a compression of the leaf springs 80 of each of the strips 76.

Furthermore, each pin 90 of the second module 20 is received in a pocket formed by two monopolar plates 12′, 12″ of the fuel cell 10.

More particularly, the ten aligned pins 90 of the second module 20 are received in ten pockets 84 of ten bipolar plates 12, and the additional pin 95 is received in the second pocket 84 of one of the bipolar plates 12.

It is thereby possible to measure the voltage of the two consecutive cells 14 delimited between the first module 20 and the second module 20.

The prior fastening of the second module 20 to the first module 20 and to the mechanical frame 40 ensures that the pins 90 of the second module 20 are received in the corresponding pockets 84.

To this end, each pin 90 of the second module 20 is preferably forced into the respective pocket 84.

The shape of each pocket 84 advantageously guides each pin 90 of the second module 20 inside said pocket 84.

The shape of each pin 90 of the second module 20 favors an effective and durable electrical contact over time between the second module 20 and each bipolar plate 12.

Such an arrangement guarantees a solid and durable electrical contact between the pin 90 and the respective pocket 84, and consequently with the monopolar plates 12′, 12″ forming the pocket 84.

The electrical contact is in particular ensured independently of the expansion or of the vibrations which may occur during the service life of the fuel cell 10, due to the spring effect induced by the specific shapes of the pockets 84 and of the pins 90.

Thereby, the calculators comprised in the modules 20 are connected directly to the cells 14, without the need for cables.

The example shown comprises two modules 20, however the fuel cell 10 is not limited to two modules but may comprise more of same, e.g. ten modules 20 to connect two hundred cells 14.

Similarly, in the example illustrated, each module 20 includes ten aligned pins 90 configured to connect ten pockets 84 of ten bipolar plates 12 to said module 20. The number of pins 90 provided on each module 90 is not limiting, the principles of the invention, in particular, the acquisition of the electrical potentials of the bipolar plates 12 connected to the modules 20 and, if appropriate, the measurement of impedance four wires that can be transposed for measurement modules 20 comprising more or less than ten pins 90.

To install the following modules where appropriate, the method discussed in detail hereinabove, for installing the second module 20 is repeated the necessary number of times.

By means of the method according to the invention, the assembly is simple, no cable is used to connect the modules 20 to the cells 14 and the modules 20 to each other. The mounting also advantageously makes it possible not to use cables to connect the modules 20 to a motherboard. Due to the foolproofing members, each module 20 is assembled to the neighboring modules without any risk of error. The mounting of the measurement modules 20 on the stack 11, or even the replacement of the faulty modules 20, is particularly easy and quick to carry out.

Thereby, the quality of the measurements is improved, making possible a more in-depth analysis thereafter.

The modules 20, once same are installed, are suitable for determining the electrical characteristics of the stack 11 of the bipolar plates 12. Optionally, once same are installed, the modules 20 are suitable for determining diagnostic and prognostic characteristics of the stack 11 of bipolar plates 12 by means of the computer which same comprise.

For example, the characteristics comprise a state of health of the stack 11 of bipolar plates 12, the location of a cell 14 in the stack of bipolar plates 12, the voltage, the impedance and the supply of the cells 14 of the fuel cell 10.

The ten aligned pins 90 of each module 20, as well as, where appropriate, the pin 110 of the additional contact component 108 aligned with the pins 90 of the modules 20, serve to measure the voltage of two consecutive cells 14 between two consecutive pins 90, 110.

The additional pin 95 of each module 20, as well as, where appropriate, the additional contact component 108, is configured to inject a sinusoidal current into the pocket 84 wherein same is received, and thereby makes it possible to make an impedance measurement on the number of cells 14 that each module 20 covers, more particularly twenty cells 14 in the example shown, when the fuel cell 10 is in operation.

In operation, the fuel cell 10 has an output current of up to 500 A—Amps—depending on the technology of the stack.

The injected sinusoidal current has a frequency between 100 Hz—Hertz—and 5 kHz—kilohertz—, more particularly between 500 Hz and 2 KHz.

The sinusoidal current injected into the stack 11 induces a voltage response on the order of a few mV—millivolt—. The voltage can be measured by an analog/digital converter equipped with an amplifier stage.

Within the measured voltage signal, the measurement module 20 isolates the voltage component having the same frequency as the injected sinusoidal current. The impedance is then calculated in a measurement module 20 as the ratio between the amplitude of the voltage component and the amplitude of the injected sinusoidal current.

An impedance value is typically calculated every second.

Each module 20 injects a current independently of the other modules 20, thereby the frequency of the injected currents can vary from one module 20 to another. Each module 20 injects a current independently of the other modules 20, thereby the frequency of the injected currents can vary from one module 20 to another. It is thereby possible to make four-wire impedance measurements simultaneously, on a plurality of measurement modules 20.

The measured impedance is between 5 mΩ—milliohm—and 20 mΩ for twenty cells 14, preferably about 10 mΩ for twenty cells 14.

Such a value is advantageously low, and such a configuration serves to make modular multifrequency impedance measurements, instead of performing a single impedance measurement on the entire stack 11 of bipolar plates. Reliability is thus improved.

By means of the method according to the invention, the assembly is simple, no cable is used to connect the modules 20 to the cells 14 and the modules 20 to each other. The mounting also advantageously makes it possible not to use cables to connect the modules 20 to a motherboard. Thereby, the quality of the measurements is improved, making possible a more in-depth analysis thereafter.

The aforementioned embodiments and variants can be combined with each other so as to generate additional embodiments of the invention.

1-25. (canceled)

26. A fuel cell comprising:
a stack of bipolar plates along a direction of stacking, two consecutive bipolar plates forming a cell therebetween;
two end plates on each side of the stack; and
a plurality of measurement modules connected to the bipolar plates, each measurement module comprising:
at least one printed circuit including a calculator suitable for determining the electrical characteristics of the stack of bipolar plates; and
a mechanical frame for holding the measurement modules, wherein the measurement modules are fastened to the mechanical frame, connected to each other and connected to the stack of bipolar plates, without the intermediary of cables.

27. The fuel cell according to claim 26, wherein the mechanical frame includes:
two pivot brackets, each pivot bracket being fastened to an end plate;
a pivot shaft extending from one pivot support to the other pivot support substantially parallel to the direction of stacking; and
a fastening rail extending from one pivot support to the other pivot support substantially parallel to the direction of stacking and the pivot shaft; and
wherein the mechanical frame is configured so that all measurement modules are framed by the frame.

28. The fuel cell according to claim 27, wherein the fastening rail is provided with openings for passage of means for fastening each pivot support to the fastening rail, wherein said openings are oblong.

29. The fuel cell according to claim 26, wherein each measurement module is covered by a shell that comprises foolproofing members, which assemble to each other by foolproofing.

30. The fuel cell according to claim 29, wherein:
the foolproofing members include a male fastening element complementary to a female fastening element; and
each shell is provided on a first transverse side with the male fastener, whereas the female fastener is formed in a second transverse side of the shell opposite the first side.

31. The fuel cell according to claim 30, wherein the male fastener is a stud and the female fastener is an arc-shaped groove allowing the stud to pivot in the groove.

32. The fuel cell according to claim 29, wherein each shell has a cylindrical groove mating with the pivot shaft.

33. The fuel cell according to claim 29, wherein each shell has a lug for fastening to the fastening rail.

34. The fuel cell according to claim 29, wherein each measurement module is connected to a connection strip connecting the measurement modules together, having leaf springs placed on each side of the strip along a transverse direction perpendicular to the direction of stacking, in such a way that the contact of the shell of a first measurement module with the shell of a second neighboring measurement module generates a compression of the leaf springs of each of the strips.

35. The fuel cell according to claim 26, wherein each measurement module is connected to the stack of bipolar plates by means of pins apt to be inserted into pockets formed in the bipolar plates.

36. The fuel cell according to claim 27, wherein one of the pivot supports a connector for connecting the stack of bipolar plates to a motherboard.

37. The fuel cell according to claim 27, wherein one of the pivot supports carries an additional component for the contact with the bipolar plate closest to said pivot support, apt to connect said bipolar plate to the neighboring measurement module.

38. A vehicle comprising at least one fuel cell according to claim 26.

39. A method of installing measurement modules on a fuel cell according to claim 26, the method comprising:
fastening each measurement module to the mechanical frame; and
connecting the measurement modules to each other and to the stack of bipolar plates without the intermediary of cables.

40. A fuel cell comprising:
a stack of a plurality of bipolar plates along a direction of stacking, each bipolar plate as such being formed by two superimposed monopolar plates comprising an anode plate and a cathode plate, two consecutive bipolar plates forming therebetween a cell;
two end plates on each side of the stack; and
a plurality of modules for measuring the electrical characteristics of the cells, each module comprising a printed circuit including a computer suitable for determining the electrical characteristics of the stack of bipolar plates;
wherein two successive monopolar plates together form at least one pocket for each receiving a pin of said module, each pocket being shaped to cooperate with said pin and having a circumferential wall, and wherein each pin of said module has a shape such that the pin exerts two opposing forces on the circumferential wall of the pocket after the pin is inserted into the pocket.

41. The fuel cell according to claim 40, wherein two successive monopolar plates are arranged back-to-back to form the at least one pocket.

42. The fuel cell according to claim 40, wherein each pin extends substantially along a first direction, and has, over a portion, an incision along said first direction separating said portion into two sub-portions on either side of the incision, each sub-portion having a bulge along a second direction, the second direction being perpendicular to the first direction, the bulges of the two sub-portions extend in opposite directions along the second direction.

43. The fuel cell according to claim 42, wherein the second direction is perpendicular to a third direction which is perpendicular to the first direction, the two sub-portions being separated from each other on each side of the incision along the third direction.

44. The fuel cell according to claim 42, wherein the incision extends along said first direction between a proximal end and a distal end, and the two sub-portions are linked together at distal and proximal ends of the incision.

45. The fuel cell according to claim 40, wherein each pocket has an open end where the circumferential wall has a conical shape.

46. The fuel cell according to claim 40, wherein the circumferential wall of each pocket has a stamping so as to form a passage of small section for a pin.

47. The fuel cell according to claim 40, wherein two successive bipolar plates are stacked head-to-tail so that only the at least one pocket of every other bipolar plate is flush in the vicinity of the modules.

48. The fuel cell according to claim 40, wherein each bipolar plate forms exactly two pockets for receiving a pin each.

49. The fuel cell according to claim 40, wherein each module has ten aligned pins configured to connect ten pockets of ten separate bipolar plates to said module, and an additional pin for connecting the second pocket of one of the ten bipolar plates to said module.

50. A vehicle comprising at least one fuel cell according to claim 40.
